(19) United States
(12) Patent Application Publication
(10) Pub. No.: US 2003/0204475 A1
(43) Pub. Date: Oct. 30, 2003

(54) Method for the prevention of the unauthorized payments of funds

(76) Inventor: Nicholas Cuda, Chicago, IL (US)

Correspondence Address: FACTOR & PARTNERS, LLC, 1327 W. WASHINGTON BLVD., SUITE 5G/H, CHICAGO, IL, 60607, US

(21) Appl. No.: 10/134,312

(22) Filed: Apr. 29, 2002

(51) Int. Cl. G06F 17/60

(52) U.S. Cl. 705/64

(57) ABSTRACT

The present invention discloses a method for preventing the unauthorized payment of funds, comprising the steps of maintaining a customer authorization database capable of receiving and storing an authorization communication from an order-maker, receiving a payment request for a payment amount from a payee, evaluating the payment request by consulting the customer authorization database, and paying the payment amount to the payee if the step of evaluating results in a positive response. Additionally, the method can include the step of returning the payment request unpaid if the step of evaluating results in a negative response. Through this process, banking/lending institutions can verify authorization of payment from a customer, in an attempt to insure that all payments made out of the bank are free of fraud.

### BACKGROUND

1. Field of the Invention

The invention relates generally to banking and/or lender methods for authorizing payments, and specifically to an improved method for verifying the authenticity of a presented payment request.

2. Background of the Invention

Banking institutions act as repositories for and guardians over their customers' assets. In particular, banks provide services for their customers whereby the bank promises to pay amounts of money to third parties upon a customers' order to do so. Commonly, such orders are in the form of checks, but may also be in the form of money orders and the like. Upon presentment of a properly endorsed check to the bank by a third party, the bank is obliged to exchange that check for an amount of the customer's assets, already held with the bank. Therefore, the bank itself decides whether to accept the check, or money order, and as such, the bank acts as the final step in the chain of custody for a customer's order to pay.

Similarly, credit card companies act as guarantors of payment for their customers. A credit card company states that, upon processing of a credit card payment by a payee, either electronically at the time of purchase or at the end of the day, the stated amount will be given to the payee, and then recouped from the credit card holder at a later time. The credit card company relies upon the credit card holder and the payee to establish that the owner of the card is in fact genuine before authorization is completed. However, in any case, the credit card company again acts as the last step in the chain, assuring payment to the payee as soon as the transaction is complete.

Part of the responsibility that comes with being the final step in this chain is that the Bank and Credit Card companies may be held responsible for paying on fraudulent checks and/or credit card payments. Fraudulent checks may be in the form of fraudulently endorsed checks, fraudulently manufactured checks, or any number of other problems by which the Bank's customer did not intend to pay that particular party, or did not intend to pay them the specified amount. Fraudulent credit card payments can be 1i 0 accomplished electronically, or through some mechanical means. In fact, as technology has increased, the ability of parties to perpetrate fraud on banks and lenders has increased significantly.

In the past, banks have undertaken a number of different methods to prevent this kind of fraud. Specifically, banks have included video surveillance devices in their lobbies, require photo identification upon presentment of a check, and numerous other methods to connect the identity of the person seeking to cash the check with the name or names written on the check. However, such methods are quickly becoming outdated.

Particularly, the increase in technology has virtually eliminated the utility of photo identification and surveillance as a method for either deterring or preventing check fraud. Scanners, paper supply stores, color printers, and high-resolution printing have all combined to provide scrupulous parties of all sorts the tools and the functionality to duplicate checks, signatures, and even photo identifications in order to provide someone with the means and identity to appear as a perfectly acceptable customer to any banking institution, regardless of their procedures and care. Further, the existence of an example signature on any credit card stands as little obstacle to its fraudulent use.

Therefore, it is an object of this invention to provide an alternative and improved method for verifying the veracity of a check, money order or credit card payment upon presentment to a banking institution or the like. Further, it is an object of this invention to ensure that this method will not unduly burden the banking industry.

These and other objects will become apparent in view of the present Specification, claims and Drawings.

### SUMMARY

The present invention comprises a method for preventing the unauthorized payment of funds, comprising the steps of maintaining a customer authorization database capable of receiving and storing an authorization communication from an order-maker; receiving a payment request for a payment amount from a payee; evaluating the payment request by consulting the customer authorization database; and paying the payment amount to the payee if the step of evaluating results in a positive response. Further, the method may additionally include the step of returning the payment request unpaid if the step of evaluating results in a negative response. This method alters the general logic of bank payments, changing it from pay on demand, to pay on authorization. In doing so, the financial institution assures that all payments made are authorized, preventing fraud and additional liability.

In a preferred embodiment of the invention, the payment request is in the form of order paper, and the step of returning comprises marking the order paper as not authorized for payment. Once this is done, the method may further comprise the steps of receiving the order paper payment request after the step of marking; evaluating the payment request by consulting the customer authorization database; and paying the payment amount to the payee if the step of evaluation results in a positive response. Alternatively, the method may additionally include the step of remarking the order paper as payment not authorized if the step of evaluating results in a negative response.

The payment requests can be in many forms. For example, the order paper of the present invention can comprise a check or a money order. Also, the payment request may comprise the presentation of credit card authorizations for payment.

### BRIEF DESCRIPTION OF THE DRAWINGS

FIG. 1 comprises a flowchart representation of the present invention.

### BEST MODE FOR PRACTICING THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

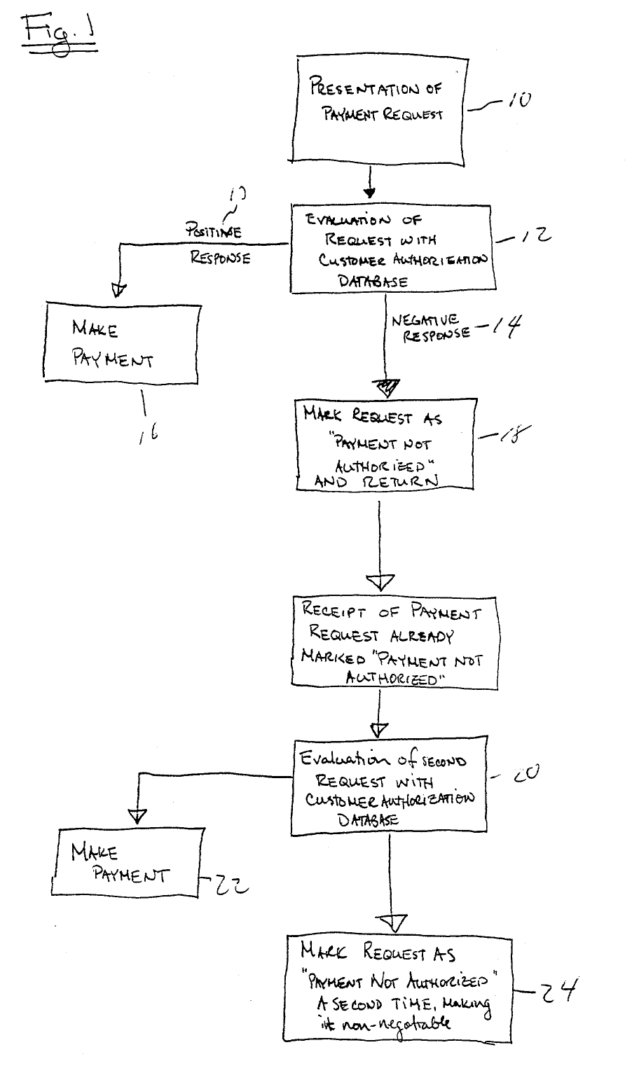

The present invention comprises a method for preventing the unauthorized payment of funds, which is most beneficially used by bank institutions and/or lenders. The method, as shown generally in the flow chart in FIG. 1, enables a banker/lender to verify the authorization of a payment from the person who made the payment, as opposed to relying on a system of preventative measures that current technology has, in many cases, rendered moot. In order to prevent unauthorized payments, the banker/lender should (a) maintain a customer authorization database capable of receiving and storing an authorized communication from an order-maker, so that when the bank (b) receives a payment request for a payment amount from a payee, the bank may (c) evaluate the payment request by consulting the customer authorization database, and (d) pay the payment amount to the payee if the step of evaluating returns a positive response. By following these steps, a banker/lender can assure that any payments made out to parties are authorized.

For the purposes of this explanation, a standard check transaction will be described. It should be noted, however, that any number of financial transactions could similarly be used with the disclosed method. In fact, any transaction in which a customer of a banking/lending institution issues an order to pay an amount of money from the institution, whether by check, money order, credit card, or the like, to a payee such as a store owner, could similarly be used with this invention. However, because of the need for clarity and brevity, the main portion of this discussion will focus on check transactions.

Traditionally, a transaction between a consumer and a business is conducted with an exchange of goods for money. If a consumer has made a decision to pay that money with a check, the consumer fills in the required blanks on the check form, including payee, date, amount, and signature, and exchanges that check with the business to receive the desired goods. Once passed to the business, the check is then endorsed, and sent on to the particular banking institution that backs the check for payment of the funds. If at any point in time in this sequence fraud occurs, either by the customer, business, or in between, the check comprises a fraudulent payment request, and will result in liabilities for one or more of the parties involved.

However, the present invention alters the general methodology for payment of checks by institutions, by changing the payment method from pay on demand, to pay on authorization. In general, the present method would alter the above-described sequence to additionally include the step of the customer authorizing the purchase to a customer authorization database, maintained by the banking/lending institution. Thereafter, upon presentment of the check to the banking/lending institution, the authorization can be checked against the presented check, confirmed, and payment made. Because of the additional authorization step, the check and check amount is confirmed to have come from the customer, and not from another anomalous party.

In order to facilitate the present method, it is necessary for the bank/institution to maintain a customer authorization database. This database, capable of holding a great number of database entries, contains general identifying information for each customer, including name and account number, and connects this information to a number of authorization records and historical information related to those records. The database must be configured for communication with customers, either by phone, by fax, through the Internet (either directly or through a wireless device, through a local area network, or some other equivalent method.) Through these methods, a customer can communicate information to the database regarding authorized transactions, such as amount, date, check number, and payee. These records are stored in customer authorization database for a period of time.

Once in place, the customer authorization database enables the successful enactment of the present method. As described above, a typical consumer transaction can involve the exchange of goods for money or its equivalent, such as a check. In the present method, a consumer prepares a check, signs it, and exchanges that check for the desired goods. At any time, either prior to or after the transaction, the consumer can communicate authorization information to the customer authorization database via any of the enumerated means above. After completion of the exchange, the consumer receives the goods, and business continues.

In a typical business, a particular day's check transactions are collected and endorsed by the business, and then prepared for transfer to a banking institution. Once at the institution, the business' representative presents the checks for payment, and may receive funds in return. In the present method, once a check or checks are presented for payment, and before payment of any funds on those checks, they must be compared to the customer authorization database to confirm that the check payments were authorized.

Comparison of checks with the authorization database can be accomplished in a number of different ways. Typically, the customer authorization database will have some sort of interface accessible to the bank representative receiving the endorsed checks, such as a computer terminal. Using identifying information contained on the check, the representative can access the authorization records associated with the original consumer, and compare those records with the check being presented for payment. Based on this comparison, the bank representative can make an informed payment decision on the check.

It is also possible to have an automatic system for comparing the presented checks with the customer authorization database. For example, check scanners or wand scanners can read identifying information such as account numbers off of the checks, and feed those account numbers into the customer authorization database. These scanners may additionally be capable of entering other information from the check, such as payee, date, and amount also. Once the records are recalled, the bank representative may then compare the records with the present checks, or rely upon the scanning ability of the process to compare the records for confirmation of authorization.

In any case, the comparison of the presented check with the customer authorization database allows the bank representative to make an informed payment decision. Such a decision may be made on a variety of criteria, and that criteria may change from bank to bank. For example, a bank may establish payment criteria that require explicit authorization from a customer before payment is made on any type of check. In the alternative, a bank may allow for certain payees, such as public utilities, credit card companies, and other large businesses to be considered to be “automatically authorized” so as to receive payment on a check regardless of the existence of a specific authorization. The bank may even allow customer authorizations for a range of transactions, such as allowing customers to authorize payment of a series of checks (i.e. numbers 1000-1200), for authorizing the payment of all checks under a certain amount of money, or for authorizing checks written on a particular day. The rules on payment authorizations may be promulgated by the various banking institutions so as to adhere to standard banking practices and the needs of their specific customers.

Additionally, by accessing the customer authorization database the bank representative can ensure that there are no banking irregularities surrounding payment on the check. The customer authorization database includes historical information relating to payments that have already been made out of the customer's accounts, including amount of payments, check numbers, and other related identifying information. When the bank representative accesses the database, the information provided is additionally compared against the historical information. If a banking irregularity is shown, such as the existence of a duplicate check number, the bank representative can utilize that information in making a final payment decision. Should the bank representative choose not to pay on a duplicate check number, as would be appropriate, the procedure for doing so should be governed by standard bank-fraud procedures.

If, instead, no banking irregularities are found, the banking procedures should follow the present method. In the present method, once the decision has been made to either pay or not pay on a particular check, the bank representative, following current banking practices, copies down standard identification information, and either presents the cash or cash equivalent to the check (if the evaluation returned a positive result), or stamps the check “Payment Not Authorized” (PNA) (if the evaluation returned a negative result). A check that has been stamped “PNA” is still negotiable, and as such is handed back to the person presenting the check. That person is informed that the current check has not been authorized for payment, and that she should contact the person who prepared the check to ensure authorization is made before presenting the check again.

After the check is returned to the payee stamped “PNA,” that party may present the check for payment a second time. Again, the bank representative receiving the payment request on the check will compare the specific check with the authorizations in the customer authorization database. The bank representative will again evaluate the information in the database, and the specific payee, and make a payment decision on the presented check. If the bank representative decides to pay on the check, it is exchanged for an amount of money or money's equivalent after recording of basic identification information. If the bank representative decides not to pay on the check, it is stamped “PNA” a second time, and the check is no longer negotiable.

Any time payment is refused on a particular check, the responsibility for the nonpayment falls to the person who originally drafted the check. As that person is the customer of the bank, and the person responsible for authorizing payment on the check, the bank's refusal to pay on the check due to a lack of authorization is a direct result of action or inaction on the drafter's part. Therefore, any fees that would be associated with non payment, such as a late payment fee, should be assessed to the drafter. Further, as a bank promulgates rules relative to the payment decisions to be made, non-compliance with those rules may allow the bank to assess charges to the customer. For example, the failure to authorize payment to a public utility may result in a fee similar to a non-sufficient funds fee, if such a utility is among the payees to whom payment should be made regardless of the existence of a specific authorization. The responsibility for compliance with these rules should, regardless, lie with the authorizing party, or customer.

The general logic for this method is illustrated in a flowchart in FIG. 1. As can be seen, the process begins upon presentation of a payment request 10. Thereafter, the payment request is evaluated 12 using the customer authorization database to compare the request against authorizations already entered there. This evaluation either returns a positive 13 or a negative 14 result, either allowing payment to be made 16, or requiring refusal of payment respectively. If payment is made, standard banking practices are followed allowing identification information to be taken, etc. If payment is refused, the payment request is marked as “Payment Not Authorized,” 18 and returned to the person or party presenting the request.

Once returned, the payment request does not cease to have value. Instead, the payment request may be presented for payment a second time 20. As can be seen in FIG. 1, the process associated with the second presentation of the payment request is similar to the above-described process. The request is evaluated using the authorizations in the customer authorization database to determine if payment is authorized. If the evaluation process returns a positive result, payment is made 22 on the request following standard banking procedures. However, if the evaluation returns a negative result, the payment request is marked as “Payment Not Authorized” 24 a second time. Once the request is marked twice, the request becomes non-negotiable, and loses all value.

By following the above process, all manner of fraudulent intervention in the relationship between payor, payee and bank/lender can be greatly reduced.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A method for preventing the unauthorized payment of funds, comprising the steps of:
maintaining a customer authorization database capable of receiving and storing an authorization communication from an order-maker;
receiving a payment request for a payment amount from a payee;
evaluating the payment request by consulting the customer authorization database; and
paying the payment amount to the payee if the step of evaluating results in a positive response.

2. The method according to claim 1, additionally including the step of returning the payment request unpaid if the step of evaluating results in a negative response.

3. The method according to claim 2, wherein the step of receiving a payment request comprises receiving a payment request in the form of order paper and the step of returning the payment request unpaid includes the step of marking the order paper as not authorized for payment.

4. The method according to claim 3, further comprising the steps of:
receiving the order paper payment request after the step of marking;
evaluating the payment request by consulting the customer authorization database; and
paying the payment amount to the payee if the step of evaluating results in a positive response.

5. The method according to claim 4, additionally including the step of remarking the order paper as payment not authorized if the step of evaluating results in a negative response.

6. The method according to claim 3, wherein the step of receiving a payment request in the form of order paper comprises receiving a payment request in the form of a check.

7. The method according to claim 3, wherein the step of receiving a payment request in the form of order paper comprises receiving a payment request in the form of a money order.

8. The method according to claim 1, wherein the step of receiving a payment request comprises the step of receiving credit card authorizations for payment.

9. The method according to claim 1, wherein the step of evaluating the payment request comprises the step of comparing the payment request with a list of authorized payments contained within the customer authorization database.

10. The method according to claim 9, wherein the step of paying the payment if a positive response results comprises the step of paying the payment request if the payment request exactly matches one of the authorizations in the list of authorized payments.

11. The method according to claim 9, wherein the step of paying the payment request if a positive response results comprises the step of paying the payment request if the payee presenting the payment request is an automatically authorized payee.

12. The method according to claim 1, wherein the step of evaluating the payment request comprises the step of comparing the payment request with a list of authorized payment request ranges contained within the customer authorization database.

13. The method according to claim 12, wherein the step of paying the payment request if a positive response results comprises the step of paying the payment request if the payment request falls within the at least one of the payment request ranges contained within the customer authorization database.

14. The method according to claim 12, wherein the step of comparing the payment request with a list of authorized payment request ranges comprises the step of comparing the payment request with a list of authorized check numbers.

15. The method according to claim 12, wherein the step of comparing the payment request with a list of authorized payment request ranges comprises the step of comparing the payment request with a list of authorized payment dates.

16. The method according to claim 12, wherein the step of comparing the payment request with a list of authorized payment request ranges comprises the step of comparing the payment request with a list of authorized payment amounts.

17. The method according to claim 1, wherein the step of evaluating the payment request comprises the step of comparing the payment request with a history of payments made out of the customer's accounts.

18. The method according to claim 17, wherein the step of paying the payment amount to the payee if the step of evaluating results in a positive response comprises the step of paying the payment amount if no banking irregularities are found in the evaluating step.

19. The method according to claim 17, additionally comprising the step of following standard bank-fraud procedures if the step of banking irregularities are found in the evaluating step.
